(19) United States
(12) Patent Application Publication
(10) Pub. No.: US 2024/0412883 A1
(43) Pub. Date: Dec. 12, 2024

(54) METHOD FOR MANUFACTURING A NUCLEAR FUEL ELEMENT AND NUCLEAR FUEL ELEMENT

(71) Applicant: FRAMATOME, COURBEVOIE (FR)

(72) Inventors: Bertrand STEPNIK, Paris (FR); Michel GRASSE, Paris (FR); Christophe MOYROUD, Paris (FR); Christophe JAROUSSE, Paris (FR)

(21) Appl. No.: 18/577,191

(22) PCT Filed: Jul. 6, 2022
(86) PCT No.: PCT/EP2022/068676

§ 371 Date: Jan. 5, 2024

(30) Foreign Application Priority Data
Jul. 6, 2021 (FR) 21 07291

(51) Int. Cl. G21C 21/10; B32B 15/01; G21C 3/20

(52) U.S. Cl. CPC G21C 21/10; B32B 15/017; G21C 3/20

(57) ABSTRACT

A method for manufacturing a nuclear fuel element and a nuclear fuel element includes obtaining a core, the coating of the core with an anti-diffusion layer so as to obtain a coated core, the insertion of the coated core into a cladding with interposition, between the coated core and the cladding, of one or more intermediate layer(s), and the pressing of the multilayer assembly. Each intermediate layer is being made of a ductile metal alloy and/or having a conventional yield strength which differs by no more than 30% from that of the material of the cladding, an elongation at break which differs by no more than 30% from that of the material of the cladding and/or a distributed relative elongation which differs by no more than 30% from that of the material of the cladding.

### CROSS-REFERENCE TO RELATED APPLICATIONS

This application is the U.S. National Phase of PCT Appl. No. PCT/EP2022/068676 filed Jul. 6, 2022, which claims priority to FR 21 07291, filed Jul. 6 2021, the entire disclosures of which are incorporated by reference herein.

### TECHNICAL FIELD

The present disclosure relates to the field of nuclear fuel elements, in particular those intended for use, for example, as a primary target or as nuclear fuel in research reactors.

### BACKGROUND

It is possible to provide a nuclear fuel element comprising a core in the form of a sheet containing a fissile material such as a uranium-based alloy, and a cladding enveloping the core in a sealed manner, the cladding being made, for example, of an aluminum-based alloy.

Such a nuclear fuel element can be inserted into a nuclear reactor for irradiation to obtain particular fission products, or into a research reactor to produce neutrons.

Such a nuclear fuel element can be used, for example, as a primary target for the production of molybdenum-99 for subsequent use as a source of technetium-99, and in particular as a source of metastable technetium-99 for use as a radioactive tracer in medicine and biology.

To produce a nuclear fuel element, it is possible to use a “picture-in-frame” manufacturing method.

According to this technique, a core containing fissile material and having a form of a rectangular sheet is inserted into an opening in a rectangular frame, and the frame containing the core is sandwiched between two closure plates. The assembly is then pressed together to bond the closure plates to the frame and core.

Pressing is carried out, for example, by rolling between rollers, by hot isostatic pressure (HIP), by spark plasma sintering (SPS) or by cold pressing with a press, by subjecting the assembly to pressure.

During pressing, it is preferable to apply a high pressure at room temperature or at a high temperature, to obtain good adhesion of the closure plates to the frame and to the core, but too high a temperature or too high a pressure can affect the core, and thus affect the performance of the nuclear fuel element.

### SUMMARY

An aims of the present disclosure is to propose a method for manufacturing a nuclear fuel element that can be easily implemented while allowing a nuclear fuel element, which presents satisfactory performance, to be obtained.

To this end, the present disclosure proposes a method for manufacturing a nuclear fuel element, the manufacturing method comprising obtaining a core in the form of a sheet containing a uranium-based fissile material, coating the core with an anti-diffusion layer to obtain a coated core, inserting the coated core into a cladding with interposition, between the coated core and the cladding, of one or more intermediate layer(s), and pressing the multilayer assembly thus obtained to seal the cladding, each intermediate layer being made of a ductile metal alloy and/or having a conventional yield strength which differs by no more than 30% from that of the cladding material, an elongation at break which differs by no more than 30% from that of the cladding material and/or a distributed relative elongation which differs by no more than 30% from that of the cladding material.

The anti-diffusion layer prevents diffusion of fissile material to the outermost layers of the nuclear fuel element, in particular to the cladding.

Each intermediate layer, made of a ductile material and/or with mechanical properties close to those of the cladding and interposed between the cladding and the core coated with the anti-diffusion layer, facilitates adhesion between the cladding and the core coated with the anti-diffusion layer. In particular, it allows to limit the pressure and, where applicable, the temperature at which the assembly is pressed, and thus to limit thermal and mechanical stresses, particularly those applied to the core.

Each intermediate layer also allows the risk of oxidation of the anti-diffusion layer during the manufacturing method to be limited, particularly during heating when pressing is carried out at high temperature.

Ultimately, the method allows a nuclear fuel element to be obtained presenting good performance, and in particular a high nuclear fuel density, with pressurization carried out at an acceptable temperature and pressure.

According to particular embodiments, the manufacturing method comprises one or more of the following optional features, taken individually or in any technically possible combination:
each intermediate layer is applied to the coated core or to an inner surface of the cladding before enveloping the coated core in the cladding;
each intermediate layer is applied to the coated core or to the cladding by spraying before enveloping the coated core in the cladding;
the material of the intermediate layer or of at least one of the intermediate layers comprises a matrix and at least one additive element;
the material of the intermediate layer or of at least one of the intermediate layers comprises a matrix and at least one additive element;
the core is a monolithic core constituted of fissile material or a dispersed core containing fissile material dispersed in a matrix;
the anti-diffusion layer is made of a material selected from among a zirconium-based alloy, a molybdenum-based alloy, a titanium-based alloy, a silicon-based alloy or a mixture of at least two of these alloys;
each intermediate layer is made of a material presenting a ductility equal to or greater than that of the anti-diffusion layer material and equal to or greater than that of the cladding material;
each intermediate layer is made of pure aluminum or an aluminum alloy, or of a material comprising a matrix made of pure aluminum or an aluminum alloy.

According to another aspect, the present disclosure relates to a nuclear fuel element comprising a core in the form of a sheet containing a uranium-based fissile material, the core being coated with an anti-diffusion layer and enveloped in a cladding, the nuclear fuel element comprising at least one intermediate layer, each intermediate layer being interposed between the anti-diffusion layer and the cladding, each intermediate layer being made of a ductile metal alloy and/or having a conventional yield strength, an elongation at break and/or relative elongation close to those of the cladding material.

According to particular implementation modes, the fuel element comprises one or more of the following optional features, taken individually or in any technically possible combination:
the fissile material contains at least one uranium alloy and/or at least one uranium compound;
the core is a monolithic core constituted of the fissile material or a dispersed core containing the fissile material dispersed in a matrix;
the anti-diffusion layer is made of a material selected from among a zirconium-based alloy, a molybdenum-based alloy, a titanium-based alloy, a silicon-based alloy or a mixture of at least two of these alloys;
each intermediate layer is made of a material more ductile than the anti-diffusion layer material and more ductile than the cladding material;
each intermediate layer is made of pure aluminum or an aluminum alloy, or of a material comprising a matrix made of pure aluminum or an aluminum alloy.

### BRIEF SUMMARY OF THE DRAWINGS

The present disclosure and its advantages will be better understood on reading the following description, given only as a non-limiting example, and made with reference to the appended drawings, on which:

FIG. 1 is a schematic front view of a nuclear fuel element;

FIG. 2 is a schematic cross-sectional view of the nuclear fuel element, according to line II-II in FIG. 1; and

FIGS. 3 to 6 are schematic views illustrating steps in a method for manufacturing the nuclear fuel element of FIGS. 1 and 2.

### DETAILED DESCRIPTION

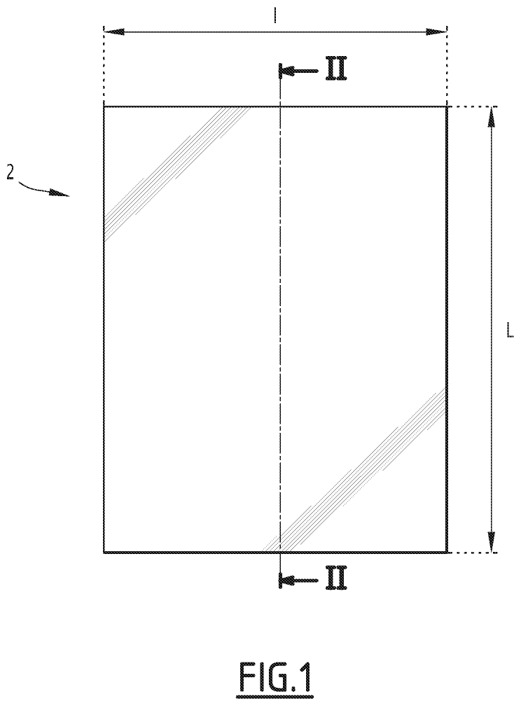

The nuclear fuel element 2 shown in FIG. 1 is intended to be used, for example, as a primary target in a nuclear reactor for obtaining fission products, or as a nuclear fuel in a research reactor for obtaining neutrons.

The nuclear fuel element 2 presents the form of a plate, for example in the form of a rectangular plate,

As shown in FIG. 1, in one embodiment the nuclear fuel element 2 presents the form of a flat plate.

In other embodiments, the nuclear fuel element 2 presents the form of a bent plate or a plate in the form of a tube, for example and, in a non-limiting manner, a tube of circular, elliptical or polygonal cross-section, in particular square or hexagonal.

The nuclear fuel element 2 in the form of rectangular plate has, for example, a length L of around 80 mm for a “mini-plate” or primary target or a length L of between 600 mm and 1,200 mm, for example a length L of around 800 mm, for nuclear reactor fuel, a width I of 20 to 90 mm and a thickness E of between 1.2 mm and 2.6 mm, in particular a thickness E of around 2 mm.

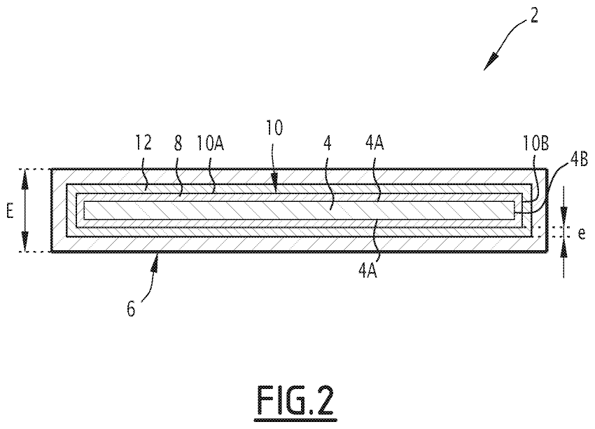

As can be seen from FIG. 2, which shows a cross-sectional view of the nuclear fuel element 2, the nuclear fuel element 2 comprises a core 4 containing fissile material, and a cladding 6 enveloping the core 4 in a sealed manner.

The cladding 6 prevents the fissile material contained in the core 4 from escaping to the outside. The cladding 6 also retains the fission products generated during irradiation of the nuclear fuel element 2.

The cladding 6 is, for example, made of an aluminum alloy, in particular an aluminum-based alloy. The cladding 6, in particular, is made from a 6061 series aluminum alloy, a 5754 series aluminum alloy or an AlFeNi aluminum alloy.

The core 4 presents in the form of a sheet. The core 4 has two opposing faces 4A and an edge 4B.

The core 4 preferably has a contour corresponding to that of the nuclear fuel element 2.

When the nuclear fuel element 2 presents the form of a rectangular plate (for example, flat, bent or form of a tube), the core 4 has the form of a rectangular sheet, as in the example shown in FIGS. 1 and 2.

In one example of the embodiment, the core 4 has a substantially constant thickness. Alternatively, the core 4 has a variable thickness. In a particular example of the embodiment, the variable thickness core 4 presents a thickness that decreases from the center of the core toward its periphery. The core 4 is thicker at its center and thinner at its periphery.

The fissile material is a uranium-based material, that is, a material containing uranium. The uranium contained in the fissile material is, for example, low-enriched uranium (LEU).

In low-enriched uranium, the proportion of the U₂₃₅ isotope in the uranium is less than 20% by weight, in particular around 19.75% by weight.

The fissile material contains, for example, a uranium alloy and/or a uranium compound. In particular, the fissile material constituted of a uranium alloy or constituted of a uranium compound or constituted of a mixture of a uranium alloy and a uranium compound.

A uranium alloy is an alloy containing uranium and at least one other metal compound, and optionally one or more non-metal compounds.

A uranium alloy is, for example, a uranium-based metal alloy. By “uranium-based” alloy is meant an alloy containing at least 60% by mass of uranium. The uranium alloy is, for example, UAl₄ containing 68.80% by mass of uranium.

In one example of the embodiment, the fissile material contains a uranium alloy which is a binary uranium alloy, that is, an alloy strictly composed of uranium and another compound, for example a binary uranium-silicon alloy, a binary uranium-molybdenum alloy, a binary uranium-aluminum alloy, a binary uranium-zirconium alloy, etc.

Alternatively, the fissile material contains a uranium alloy which is a uranium ternary alloy, that is, an alloy strictly composed of uranium and two other compounds, for example a uranium-molybdenum-X ternary alloy, X being a third metallic or non-metallic chemical element.

The third chemical element X is, for example, selected from among tin (Sn), titanium (Ti), palladium (Pd), osmium (Os), rhodium (Rh), ruthenium (Ru), vanadium (V), silicon (Si), chromium (Cr), niobium (Nb), strontium (Sr), platinum (Pt), hydrogen (H), zirconium (Zr), oxygen (O), nitrogen (N), aluminum (Al), germanium (Gr), gallium (Ga) or antimony (Sb).

In a particular example of the embodiment, the fissile material is a binary uranium-molybdenum alloy.

Preferably, the binary uranium-molybdenum alloy of the fissionable material contains less than 15% by weight of molybdenum, the remainder being constituted of uranium and unavoidable impurities.

A uranium compound is a chemical compound comprising uranium associated with one or more non-metallic chemical compounds. A uranium compound is, for example, a uranium oxide (UₓO_{y}), in particular uranium dioxide (UO₂), a uranium nitride (UₓN_{y}) or a uranium hydride (UₓH_{y}).

The core 4 is constituted of the fissile material (“monolithic” core) or contains the fissile material dispersed in a matrix made of another material (“dispersed” core), for example a metallic material, in particular aluminum.

The fissile material dispersed in a matrix is, for example, obtained by mixing, and preferably compacting, a powder constituted of the fissile material and a powder constituted of the matrix material, for example, aluminum powder.

The core 4 is coated with an anti-diffusion layer 8. The anti-diffusion layer 8 covers at least each of the two opposite faces 4A of the core 4, and optionally covers the edge 4B of the core 4. Preferably, the anti-diffusion layer covers each of the two opposite faces 4A and the edge 4B of the core 4.

The core 4 coated with the anti-diffusion layer 8 is hereinafter also referred to as the “coated core 10”. It presents in the form of a sheet and has two opposite faces 10A and an edge 10B.

The cladding 6 envelops the core 4 coated with the anti-diffusion layer 8. The anti-diffusion layer 8 is thus interposed between the core 4 and the cladding 6. The anti-diffusion layer 8 prevents diffusion of chemical species from the core 4 to the cladding 6.

The anti-diffusion layer 8 preferably has a high melting temperature. In one example of the embodiment, the anti-diffusion layer 8 has a melting temperature equal to or greater than the melting temperature of the core 4.

When the core 4 is a monolithic core the fissile material of which is constituted of a binary uranium-molybdenum alloy, for example a U₇Mo alloy, the melting temperature of the anti-diffusion layer is equal to or greater than 1250° C., which is the melting temperature of the binary uranium-molybdenum alloy U₇Mo.

The anti-diffusion layer 8 is made, for example, of a zirconium alloy, or a molybdenum alloy or a silicon alloy or a binary metal alloy, for example a zirconium-aluminum alloy (Zr/Al) or a molybdenum-aluminum alloy (Mo/Al) or a silicon-aluminum alloy (Si/Al).

The nuclear fuel element 2 comprises one or more intermediate layer(s) 12, each intermediate layer 12 being interposed between the core 4 coated with the anti-diffusion layer 8 and the cladding 6.

Each intermediate layer 12 is located between the anti-diffusion layer 8 and the cladding 6. The anti-diffusion layer 8 therefore prevents the diffusion of chemical species from the core 4 toward each intermediate layer 12.

In one example of the embodiment, the nuclear fuel element 2 comprises a single intermediate layer 12 interposed between the coated core 10 and the cladding 6.

Alternatively, the nuclear fuel element 2 comprises several superimposed intermediate layers 12 interposed between the coated core 10 and the cladding 6. The superimposed intermediate layers 12 then form a multilayer laminate formed by superimposing the intermediate layers 12 and interposed between the coated core 4 and the cladding 6.

When the nuclear fuel element 2 has several intermediate layers 12, the intermediate layers 12 are made of the same material or at least two from among the intermediate layers 12 are made of different materials, and, in a particular example embodiment, each intermediate layer 12 is made of a different material to each of the other intermediate layers 12.

Each intermediate layer 12 is made of a material which is ductile and/or has a conventional yield strength (R_{ρ0.2}), an elongation at break (A %) and/or a distributed relative elongation (A % S) close to those of the cladding material 6.

A mechanical property of a first material is considered close to that of a second material when the value of the mechanical property of the first material does not differ from the value of the same mechanical property of the second material by more than 30%, that is, the value of the mechanical property of the first material is between 70% and 130% of the value of this mechanical property of the second material.

Thus, preferably:
the material of each intermediate layer 12 has a conventional yield strength less than or equal to 60 MPa, corresponding to an intermediate layer 12 made of a ductile metal alloy, and/or
the value of the conventional yield strength of the intermediate layer material 12 does not differ from the value of the conventional yield strength of the cladding material 6 by more than 30%, and/or
the value of the elongation at break of the intermediate layer material 12 does not differ from the value of the elongation at break of the cladding material 6 by more than 30%, and/or
the value of the distributed relative elongation of the intermediate layer material 12 does not differ from the value of the distributed relative elongation of the cladding material 6 by more than 30%.

Preferably, the material of each intermediate layer 12 has an elongation at break of between 10% and 40%, and/or the material of the cladding 6 has an elongation at break of between 10% and 40%.

Preferably, the material of each intermediate layer 12 has a distributed relative elongation (A % S) greater than or equal to 10% and/or the material of the cladding 6 has a distributed relative elongation (A % S) greater than or equal to 10%.

As indicated, each intermediate layer 12 is preferably made of a ductile material. Advantageously, each intermediate layer 12 is made of a material having a ductility equal to or greater than that of the cladding material 6 and/or that of the anti-diffusion layer material 8.

Preferably, the material of each intermediate layer 12 is chosen so as not to interact chemically with the cladding 6 and/or the core 4. In particular, the material of each intermediate layer 12 is chosen so as not to interact chemically with uranium and/or aluminum.

By “chemically interact” it is understood that there is an attractivity between the atoms or molecules of these materials, the attractivity being, for example, of electrostatic origin (ionic bonding or hydrogen bonding) or quantum origin (covalent bonding, metallic bonding or Van der Waals bonding).

In one example of the embodiment, the single intermediate layer 12 or at least one of the plurality of intermediate layers 12 or each from among the plurality of intermediate layers 12 is made of pure aluminum or an aluminum alloy, in particular an aluminum-based alloy.

An aluminum-based alloy refers to an aluminum alloy containing at least 80% aluminum by weight.

In one example of the embodiment, the aluminum alloy or aluminum-based alloy contains copper (Cu), manganese (Mn) and/or zinc (Zn).

Alternatively, the single intermediate layer 12 or at least one from among the plurality of intermediate layers 12 or each from among the plurality of intermediate layers 12 is formed from a matrix containing additive elements. The matrix is chosen, for example, from the materials indicated above.

Each additive element is, for example, dispersed in the matrix or dissolved in the matrix.

Each additive element is chosen to improve the mechanical properties, thermal properties and/or neutron properties of the intermediate layer 12.

The additive elements are, for example, titanium (Ti) or silicon (Si) inclusions or neutron poison.

Each intermediate layer 12 is interposed between each of the two opposite faces 10A of the coated core 10 and the cladding 6, and optionally between the edge 10B of the coated core 10 by the anti-diffusion layer 8 and the cladding 6.

Preferably, each intermediate layer 12 is interposed between each of the two opposite faces 10A of the coated core 10 and the cladding 6, and between the edge 10B of the coated core 10B and the cladding 6. The coated core 10 is then completely surrounded by the intermediate layer 12.

The single intermediate layer 12 or the plurality of intermediate layers 12 taken collectively preferably presents a thickness e of between 10 μm and 500 μm, in particular a thickness of between 20 μm and 60 μm, even more particularly a thickness of between 30 μm and 50 μm.

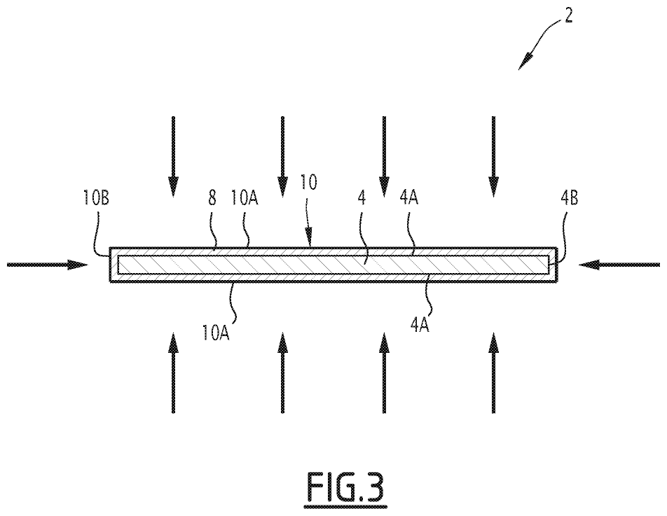

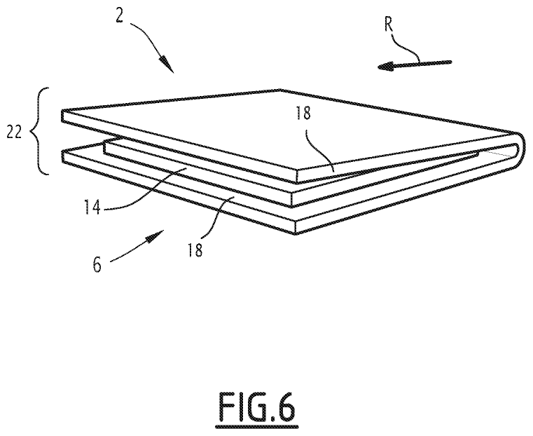

A method for manufacturing the nuclear fuel element 2 will now be described with reference to FIGS. 3 to 6, which illustrate successive steps in the manufacturing method.

The manufacturing method comprises obtaining the core 4.

The core 4, for example, is obtained in a known way by mixing powders in a furnace, each metal powder corresponding to one of the compounds of the metal alloy forming the core 4.

The core 4 containing a fissile material formed from a binary uranium-metal compound alloy (for example, molybdenum) is, for example, obtained by mixing uranium powder or wire or pieces and metal compound powder or wire or pieces (for example, molybdenum) in a furnace to combine them by a melting process.

A similar technique can be used in general for a uranium alloy, each other compound of the alloy being mixed, according to its nature, in the form of pieces, wire or powder, with the uranium, before melting the mixture in a furnace.

In one example of the embodiment, the manufacturing method comprises forming a sheet strictly from the fissile material, so as to obtain the core 4. In this case, core 4 is a “monolithic” core.

In another example of the embodiment, the manufacturing method comprises forming an ingot from the fissile material, reducing the ingot to powder, for example by grinding, mixing the fissile material powder with another material intended to form a matrix, compacting the mixture to form a compact, then sintering or simply compacting the compact to obtain the core 4. In this case, core 4 is a “dispersed” core.

The manufacturing method comprises depositing the anti-diffusion layer 8 onto the core 4, to obtain the coated core 10.

The anti-diffusion layer 8 is applied to the core 4 by co-laminating, for example. In this case, the core 4 is sandwiched between two sheets made of the material of the anti-diffusion layer 8, and the laminated assembly thus formed is laminated between rolls.

This allows the anti-diffusion layer 8 to adhere to the core 4. In such a case, the anti-diffusion layer 8 covers the two opposite faces 4A of the core 4 without covering the edge 4B of the core 4.

Alternatively, as shown in FIG. 3, the anti-diffusion layer 8 is applied to the core 4 by physical vapor deposition (PVD), for example, sputtering PVD, or by Chemical Vapor Deposition (CVD), Atomic Layer Deposition (ALD) or Plasma Enhanced Chemical Vapor Deposition (PECVD).

Alternatively, the anti-diffusion layer 8 is applied to the core by spraying, for example, cold spraying, thermal spraying or plasma spraying.

If the anti-diffusion layer 8 is applied by physical vapor deposition or spraying, the anti-diffusion layer 8 can cover the edge 4B of the core 4.

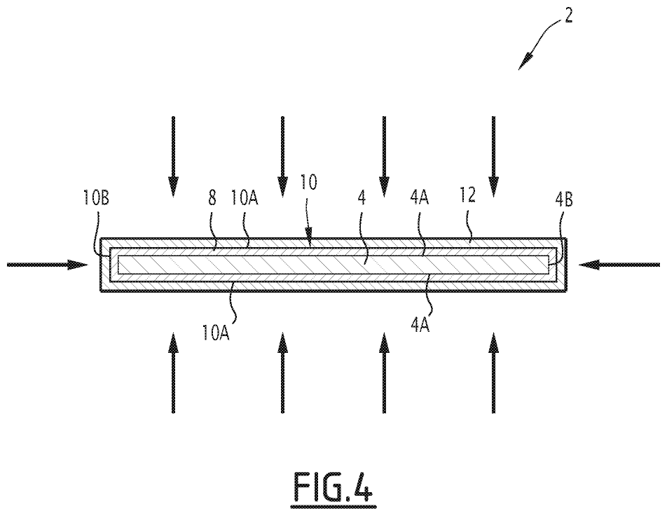

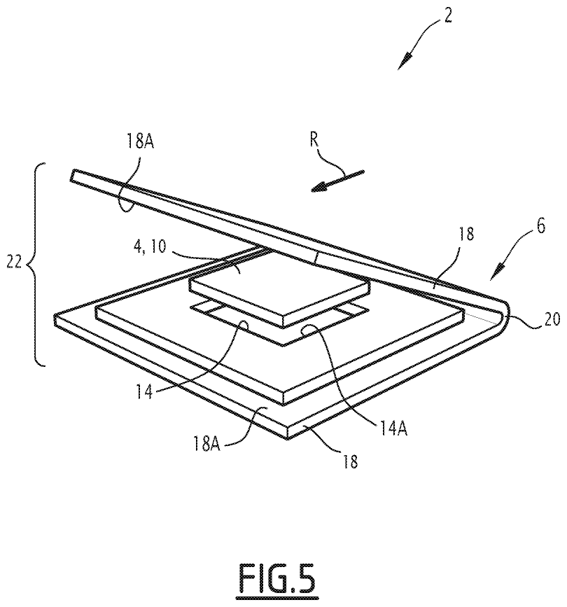

The manufacturing method then comprises inserting the coated core 10 into the cladding 6 with the intermediate layer(s) 12 interposed between the coated core 10 and the cladding 6 (FIGS. 4 and 5).

Each intermediate layer 12 can be deposited on the coated core 10 or on the cladding 6 prior to insertion of the coated core 10 into the cladding 6.

When the nuclear fuel element 2 comprises several superimposed intermediate layers 12, these are deposited successively.

In one example of the embodiment, the manufacturing method comprises depositing each intermediate layer 12 on the coated core 10 before inserting the coated core 10 into the cladding 6 (FIG. 4).

In this case, each intermediate layer 12 is deposited at least on each of the two opposite faces 10A of the coated core 10, and optionally on the edge 10B of the coated core 10. Preferably, each intermediate layer 12 is deposited on each of the two opposite faces 10A of the coated core 10 and on the edge 10B of the coated core 10.

Alternatively, the manufacturing method comprises depositing each intermediate layer 12 on the cladding 6, more precisely on an inner surface of the cladding 6 facing the core 4, before inserting the core 4 into the cladding 6.

Alternatively, when the nuclear fuel element 2 comprises several intermediate layers 12, the manufacturing method comprises depositing at least one from among the intermediate layers 12 onto the coated core 10 or onto the cladding 6 and depositing at least one from among the intermediate layers 12 onto the cladding 6.

When the coated core 10 is enveloped in the cladding 6, each intermediate layer 12 deposited on the coated core 10 overlaps with each intermediate layer 12 deposited on the cladding 6 to form the multilayer laminate.

Each intermediate layer 12 is deposited, for example, by spraying, in particular cold spraying, thermal spraying, plasma spraying, flame spraying, HVOF (High Velocity Oxygen Flame) or AWS (Arc Wire Spraying).

In one particular example of the embodiment, the deposition of the intermediate layer 12 of at least one intermediate layer 12 or each intermediate layer 12 is carried out by flame spray. The thermal flame spraying is carried out by melting the material in a flame, for example an oxyacetylene flame, the molten material being sprayed onto the substrate (core 4 or cladding 6) using a stream of gas, preferably a neutral gas, in particular argon.

The cladding 6 is formed, for example, from a number of cladding elements which are assembled together and around the coated core 4 to seal the cladding 6 tightly, the cladding 6 completely enveloping the core 4.

In one example of the embodiment, the cladding 6 comprises a frame 14 having an opening 16 for receiving the core 4, and two closure plates 18 arranged on either side of the frame 14. The frame 14 receiving the core 4 is interposed between the two closure plates 18. The two closure plates 18 sandwich the frame 14 and core 4.

As shown in FIG. 4, in one particular example of the embodiment, the two closure plates 18 are formed in one piece from a single closure sheet 18 folded in half to form the two closure plates 18 separated by a fold 20.

Alternatively, the two closure plates 18 are two separate pieces.

The frame 14 has an inner edge 14A delimiting the opening 16. Each closure plate 18 has an inner surface 18A.

When the intermediate layer 12 or at least one from among the intermediate layer(s) 12 is deposited on an inner surface of the cladding 6, deposition is carried out on the inner surface 16A of one or each of the closure plates 18, and optionally on the inner edge 14A of the frame 14. Preferably, deposition is carried out on the inner surface 18A of each of the closure plates 18, and on the inner edge 14A of the frame 14.

The manufacturing method comprises pressing the multilayer assembly 22 formed by the coated core 10 inserted into the cladding 6 with the interposition of the intermediate layer 12.

Advantageously, pressing is carried out hot. In this case, the method comprises heating the multilayer assembly 22 before and/or during pressing.

In one example of the embodiment, pressing is carried out by rolling the multilayer assembly 22 between rollers, as illustrated by arrow R in FIG. 4. Laminating can be carried out either cold or hot.

During lamination, pressure is applied along the direction of the thickness of the multilayer assembly 22. The multi-layer assembly 22 tends to elongate.

In another example of the embodiment, pressing is performed by hot isostatic pressure (HIP).

Such pressing involves subjecting the multilayer assembly 22 to the pressure of a fluid, in a pressurization chamber, so that the pressure acts identically in all directions. The fluid is, for example, a gas, in particular air or a neutral gas.

Such pressurization results in very low elongation.

In any case, pressing is preferably carried out in such a way that the elongation or reduction ratio of the multilayer assembly 22 at the end of rolling is less than 15%, preferably less than 10%.

The elongation expressed as a percentage of the multilayer assembly 22 is the difference between the length of the multilayer assembly 22 after pressing and the length of the multilayer assembly 22 before pressing, multiplied by the value 100 and divided by the length of the multilayer assembly 22 after pressing.

The reduction ratio is the difference between the thickness of the multilayer assembly 22 after pressing and the thickness of the multilayer assembly 22 before pressing, multiplied by the value 100 and divided by the thickness of the multilayer assembly 22 after pressing.

In practice, elongation and reduction ratio are substantially equal.

The present disclosure makes it easy to manufacture a nuclear fuel element 2 with satisfactory neutron performance.

The anti-diffusion layer 8 prevents diffusion of fissile material toward the outermost layers of the nuclear fuel element 2, in particular toward the cladding 8, and also toward each intermediate layer 12.

In particular, the anti-diffusion layer 8, which has a high temperature melting point, prevents such diffusion when the temperature of the core 4 rises, for example as a result of pressing or heating when pressing is carried out at high temperatures.

Each ductile intermediate layer 12 interposed between the cladding 6 and the core 4 coated with the anti-diffusion layer 8 facilitates adhesion between the cladding 6 and the core 4 coated with the anti-diffusion layer 8 and helps limit quality defects in the fuel element.

In particular, it makes it possible to limit the pressure and, where applicable, the temperature at which the assembly is pressed, and thus to limit the thermal and mechanical stresses applied to the core 4.

Each intermediate layer 12 also allows to limit the risk of oxidation of the anti-diffusion layer 8 during the manufacturing method, particularly during heating when pressing is carried out at high temperature.

Ultimately, the manufacturing method allows a nuclear fuel element presenting good performance to be obtained, and in particular few quality defects, a high nuclear fuel density, with pressing carried out at an acceptable temperature and pressure.

The manufacturing method can be implemented with known types of equipment, in particular deposition equipment, rolling equipment or pressing equipment of known types.

The present disclosure is not limited to the examples of the embodiment discussed above and illustrated in the drawings. Other examples of the embodiment are also conceivable.

The nuclear fuel element 2 can be used as a target for isotope production and/or as a fuel for power generation, for example in a research nuclear reactor.

What is claimed is:

1-15. (canceled)

16. A method for manufacturing a nuclear fuel element, the manufacturing method comprising:
obtaining a core in the form of a sheet containing a uranium-based fissile material;
coating the core with an anti-diffusion layer to obtain a coated core;
inserting the coated core into a cladding with interposition, between the coated core and the cladding, of one or more intermediate layer(s), and pressing a resulting multilayer assembly so as to close the cladding in a sealed manner, each intermediate layer being made of a ductile metal alloy and/or having a conventional yield strength which differs by no more than 30% from that of the cladding material, an elongation at break which differs by no more than 30% from that of the cladding material and/or a distributed relative elongation which differs by no more than 30% from that of the cladding material.

17. The manufacturing method according to claim 16, wherein each intermediate layer is applied to the coated core or to an inner surface of the cladding prior to enveloping the coated core in the cladding.

18. The manufacturing method according to claim 16, wherein each intermediate layer is applied to the coated core or to the cladding by spraying before enveloping the coated core in the cladding.

19. The manufacturing method according to claim 16, wherein the material of the intermediate layer or of at least one from among the intermediate layers comprises a matrix and at least one additive element.

20. The manufacturing method according to claim 16, wherein the fissile material contains at least one uranium alloy and/or at least one uranium compound.

21. The manufacturing method according to claim 16, wherein the core is a monolithic core constituted of the fissile material or a dispersed core containing the fissile material dispersed in a matrix.

22. The manufacturing method according to claim 16, wherein the anti-diffusion layer is made of a material selected from a zirconium-based alloy, a molybdenum-based alloy, a titanium-based alloy, a silicon-based alloy or a mixture of at least two of these alloys.

23. The manufacturing method according to claim 16, wherein each intermediate layer is made of a material presenting a ductility equal to or greater than that of the material of the anti-diffusion layer and equal to or greater than that of the material of the cladding.

24. The manufacturing method according to claim 16, wherein each intermediate layer is made of pure aluminum or an aluminum alloy or of a material comprising a matrix made of pure aluminum or an aluminum alloy.

25. A nuclear fuel element, comprising:
a core in the form of a sheet containing a uranium-based fissile material;
an anti-diffusion layer;
a cladding, the core being coated with the anti-diffusion layer and enveloped in the cladding; and
at least one intermediate layer, each intermediate layer being interposed between the anti-diffusion layer and the cladding, each intermediate layer being made of a ductile metal alloy and/or having a conventional yield strength, elongation at break and/or relative elongation close to those of the material of the cladding.

26. The nuclear fuel element according to claim 25, wherein the fissile material contains at least one uranium alloy and/or at least one uranium compound.

27. The nuclear fuel element according to claim 25, wherein the core is a monolithic core constituted of the fissile material or a dispersed core containing the fissile material dispersed in a matrix.

28. The nuclear fuel element according to claim 25, wherein the anti-diffusion layer is made of a material selected from among a zirconium-based alloy, a molybdenum-based alloy, a titanium-based alloy, a silicon-based alloy or a mixture of at least two of these alloys.

29. The nuclear fuel element according to claim 25, wherein each intermediate layer is made of a material more ductile than the material of the anti-diffusion layer and more ductile than the material of the cladding.

30. The nuclear fuel element according to claim 25, wherein each intermediate layer is made of pure aluminum or an aluminum alloy or of a material comprising a matrix made of pure aluminum or an aluminum alloy.
